(19) United States
(12) Patent Application Publication
(10) Pub. No.: US 2024/0344968 A1
(43) Pub. Date: Oct. 17, 2024

(54) CORROSION MONITORING METHOD

(71) Applicant: Casale SA, Lugano (CH)

(72) Inventors: Leonardo Marrone, Mercallo (VA) (IT); Marco Ormellese, Figino Serenza (CO) (IT); Silvia Beretta, Milano (IT)

(73) Assignee: Casale SA, Lugano (CH)

(21) Appl. No.: 18/701,041

(22) PCT Filed: Oct. 11, 2022
(86) PCT No.: PCT/EP2022/078277

§ 371 Date: Apr. 12, 2024

(30) Foreign Application Priority Data
Oct. 13, 2021 (EP) 21202500.1

(51) Int. Cl. G01N 17/02; G01N 17/04

(52) U.S. Cl. CPC G01N 17/02; G01N 17/04

(57) ABSTRACT

Method for determining the corrosion rate of a piece of equipment of a urea synthesis plant, the method comprises the provision of electrodes including a working electrode immersed in an aqueous solution containing ammonium carbamate, the method further comprises the determination of polarization data of the working electrode and the determination of the corrosion rate of said piece of equipment based on said polarization data.

### FIELD OF APPLICATION

The invention is in the field of urea production. The invention particularly pertains to a method for measuring in continuous the corrosion rate in urea plants.

### PRIOR ART

In chemical plants, corrosion in general term can be seen as the deterioration of a metal or alloy as a result of the interaction with its environment.

Urea plants are particularly subjected to corrosion phenomena due to the high temperature operating conditions of the plants and due to formation during the synthesis process of a highly corrosive aqueous solution of ammonium carbamate.

In urea plants, the apparatus subjected to the most aggressive environment are the urea synthesis reactor, the urea stripper and the urea condenser. Such apparatus must be manufactured with corrosion-resistant alloys to be able to withstand corrosion.

Austenitic Stainless Steel (SS) is a Fe—Cr—Ni corrosion-resistant alloy typically used as a structural material in said plants. Unfortunately, the effectiveness of this alloy against corrosion is not absolute. For instance, when SS is exposed to an aqueous solution of ammonium carbamate that retains a too low concentration of dissolved oxygen, corrosion can occur quite rapidly (up to 50 mm/y).

In practical application, to reduce the corrosion rate of SS to an acceptable value, e.g. lower than 1 mm/year, oxygen must be continuously injected into the urea synthesis loop and dissolved into the liquid phase to ensure the continuous passivation of the alloy. During passivation, a protective oxide layer is built on the surface of the alloy and the corrosion rate is reduced to a value typically lower than 0.15 mm/year.

Unfortunately, the continuous injection of oxygen in the urea synthesis loop may not be sufficient to prevent corrosion in every operating condition experienced by the plant over time. For instance, the corrosive nature of the process fluid can be enhanced by the presence of contaminants such as chlorides or sulphides, or by the occurrence of transient variations in temperature or in chemical composition. Additionally, a low dissolution of oxygen in the liquid phase due to not adequate mixing of latter within the process gas or a not sufficient liquid-gas contacting time can drastically increase the corrosion (up to 50 mm/year) possibly leading to severe consequences e.g. the failure of components.

Therefore, in practical application corrosion monitoring techniques must be applied to verify if the corrosion rate is within an unacceptable range.

Corrosion measurements are normally performed at the periodic plant turnarounds. Techniques as eddy current, ultrasonic testing or equivalent are used to check a reduction in cross-section area or a thinning over time of the plant's components exposed to the most demanding conditions.

Unfortunately, the above mentioned techniques are not completely satisfactory to monitor corrosion because only an average corrosion rate value over a relatively long period of time can be measured. Localized spikes in corrosion rate cannot be detected and only a very limited number of corrosion data can be generated.

Alternative corrosion monitoring methods are based on ultrasonic techniques that unfortunately are not particularly attractive due to the poor detection resolution of the instruments. Furthermore, the ultrasonic methods only allow the determination of an average corrosion rate value over a relatively long period of time and again, localized spikes in corrosion rate cannot be detected.

A further disadvantage is that the ultrasonic methods can only be applied on pipes and not directly onto pressure vessels such as the urea reactor or the stripper due to technical limitations.

It is therefore highly desirable to find an alternative and more efficient method to measure the corrosion rate in urea plants. Ideally, when applied the new method should generate corrosion rate data in a very short time, should be able to detect spikes in corrosion rate and should be easy applicable both on pipes and on reactor vessels.

### SUMMARY OF THE INVENTION

The invention is based on the judicious insight that the corrosion in a urea plant is an electrochemical corrosion process that occurs in a liquid phase which brings to almost uniform thickness loss on the surface of the metal exposed to the corrosive environment (general or uniform corrosion).

The corrosion environment due to the presence of ions or salts dissolved into the aqueous electrolyte is highly electrically conductive. That is a prerequire for the application of the present method.

The present invention aims to provide a method to measure in continuous the corrosion rate in urea plants. Accordingly, one aspect of the present invention is a method for determining the corrosion rate of a piece of equipment of a urea synthesis plant, said piece of equipment is immersed with a process fluid of said urea synthesis plant, which is an aqueous solution containing ammonium carbamate.

The method comprises the provision of electrodes immersed in said process fluid, said electrodes including at least a working electrode which is made of the same material as said piece of equipment, a reference electrode and a counter electrode.

The method comprising the steps of determining polarization data of the working electrode, by varying the electrochemical potential of said working electrode with respect the reference electrode, and determining a corrosion rate of said piece of equipment based on said polarization data.

Advantageously, the method of the present invention allows to acquired multiple measures of corrosion rate in a very short period of time. Typically, a corrosion rate measurement can be acquired in order of minutes.

Even more advantageously, the method does not require the inspection or the extraction of the electrodes from the apparatus i.e. from a chemical vessel or a pipe to measure the corrosion rate but the latter can be acquired remotely and the steps required to perform the measurement can be fully automated in a control-logic.

Additionally, due to the short time frame required to acquire the polarization data, spikes in corrosion rate can be easily detected and a large set of corrosion data can be generated. The method is as well directly applicable in the determination of corrosion rate both on pipes and on reactor vessels.

### DETAILED DESCRIPTION OF THE INVENTION

The invention comprises the provision of an electrochemical probe comprising a plurality of electrodes that must be immersed in the corrosive solution. The electrodes are connected by means of electrical cables to a potentiostat or to an equivalent electronic device and preferably, said cables are made of a material or alloy characterized by a low internal resistance to the passage of the electrical current.

The potentiostat or any other suitable electronic device can be used to apply a current between two or more electrodes and to measure the established potential across them. Alternatively, the potentiostat can be used to impose a potential between two or more electrodes and to measure the electrical current flowing across them. Preferably, the electronic device can operate either in a potentiodynamic or in a galvanostatic mode.

According to the invention, the electrochemical probe comprises three electrodes namely a working electrode WE, a counter electrode CE and a reference electrode RE. Ideally, no current flows through the reference electrode during the acquisition of the polarisation data.

According to a particularly preferred embodiment, the polarization data are obtained by sweeping the electrochemical potential of said WE with respect to the RE and by measuring the current flowing between the WE and the CE. Hereinafter for simplicity the electrochemical potential difference between the WE and RE is indicated as E, and shortly referred-to as the electrochemical potential.

Preferably, the electrochemical potential of said WE relative to the RE is swept around the Open Circuit Potential (OCP) wherein the OCP is defined as the potential difference between the WE and the RE measured in absence of an electric current circulating between the WE and the CE. In practical applications, if the WE and RE are made of the same material the OCP is by definition very close to 0 mV.

ΔE is the imposed potential difference at the WE with respect to the RE, defined as:

ΔE=E−OCP

According to a particularly preferred embodiment, the electrochemical potential is swept in a range between −20 mV and +20 mV versus said OCP. More preferably between −10 mV and +10 mV versus said OCP.

The scan rate parameter that defines the potential scan rate during data acquisition is preferably lower than 20 mV/min or more preferably lower than 10 mV/min.

When the electrochemical potential of the WE, i.e. E, is varied in a small range in proximity of OCP, a polarization resistance R_{P} of the specimen forming the working electrode during the application of an external polarization can be calculated from the polarization data as follow:

$${R}_{P} = \frac{Δ E}{I}$$

ΔE is the imposed potential difference at the working electrode and/is the current flowing between the WE and the CE measured in the said ΔE potential difference. Preferably, R_{P} is determined in the anodic part of the said polarization. More preferably R_{P} is calculated at ΔE=+10 mV.

Preferably, the determination of the corrosion data includes the steps of:
determining a parameter B on the basis of the material of the working electrode and the composition of the process fluid wherein the electrodes are immersed.
determining a corrosion current I_{corr} by dividing the said parameter B by the polarisation resistance R_{P} value as follow:

$${I}_{corr} = \frac{B}{{R}_{p}}$$

finally determining the corrosion rate Cᵣₐₜₑ according to the following equation:

$${C}_{rate} = \frac{{I}_{corr}}{A} * K$$

wherein A is the surface area of the working electrode exposed to the process fluid and K is a conversion factor.

K is a conversion factor that converts the density of current (ampere/surface, for example A/cm²) into velocity of corrosion, such as mm/year. Said conversion factor K can be calculated in accordance with the standard ASTM G 102-89 “Standard Practice for Calculation of Corrosion Rates and Related Information from Electrochemical Measurements”. Particularly preferably the factor K is calculated according to par. 4.4 and Appendix X2 of said ASTM standard.

Based on experiments performed by the applicant, K is preferably comprised between 9′000 and 11′000 mm/y cm²/A. For AISI 316 steel the factor K is preferably in the range 10′600-10′700, more preferably around 10′680 mm/y cm²/A. For AISI 304 the factor K is slightly less, preferably 10′500 to 10′600, typically around 10′520 mm/y cm²/A. For a super duplex steel, suitable for use in urea equipment, the factor K is typically 9′900 to 10′000 mm/y cm²/A, preferably around 9′980 mm/y cm²/A. For example K is around 9′985 mm/y cm²/A for the steel known commercially as Uremium 29.

According to a particularly preferred embodiment, the working electrode is made of a super duplex stainless steel (austenitic-ferritic) and when it is immersed into an aqueous solution of ammonium carbamate and no passivating oxygen is injected into the solution, B can be selected in the range 3.0 to 6.0 mV, or preferably 3.5 to 5.0 mV or more preferably 4.7 mV, or around 4.7 mV.

The applicant found that when austenitic stainless steel (AISI 316L) is exposed to a deaerated solution of ammonium carbamate under urea synthesis conditions, B is comprised in the range 25 to 15 mV or preferably 20 to 17 mV or even more preferably close or equal to 18 mV.

Alternatively, B can also be calculated from the following equation:

$$B = \frac{{b}_{a} * {b}_{c}}{2.3 * ( {b}_{a} + {b}_{c} )}$$

where the parameters bₐ and b_{c} are respectively the anodic and cathodic Tafel slopes. Preferably those slopes are estimated by fitting the Butler-Volmer equation (displayed below) on the polarization data (ΔE vs I) acquired experimentally. Preferably, those data are collected within the range-50 mV÷+50 mV and more preferably between −10 mV÷+10 mV.

$$I = {I}_{corr} ( 1 {0}^{\frac{Δ E}{ba}} - 1 {0}^{\frac{Δ E}{bc}} )$$

Regression techniques can also be applied to determine said paraments.

Advantageously, the above-mentioned procedure to determine B is simplified in an aerated environment because the parameter bₐ→∞, consequently the Butler-Volmer equation can be simplified as follow:

$$I = {I}_{corr} ( - 1 {0}^{\frac{Δ E}{bc}} )$$

Fitting and regression techniques can still be applied to determinate the parameters I_{corr} and b_{c}.

According to the invention the WE is made of the same material of the piece of equipment immersed in the process fluid where the corrosion rate need to be measured and according to a particularly preferred embodiment, the reference electrode and the counter electrode are made of the same material of the WE.

The method of the present invention is particularly suited to determine the corrosion rate of a piece of equipment being part of a high-pressure urea synthesis section or urea synthesis loop, particularly a urea synthesis reactor, a urea stripper, a urea condenser or a piece thereof.

Preferably, a portion of the electrochemical probe that retains the electrodes is immersed in the process fluid by installing the probe in a pressure vessel or by withdrawing a portion of said process fluid from the pressure vessels or from a specific location of the pressure vessels in contact with a piece of equipment and sending said portion of process fluid to the electrodes.

The method of the invention can be performed continuously so that a large set of corrosion rate data can be acquired and spike in corrosion rate can also be detected.

Preferably, the electrodes are concentrically arranged on the electrochemical probe to prevent or limit the occurrence of current spread effect that may cause a displacement in potential of the electrodes.

A suitable electrochemical probe for carrying out the method of the invention is the PAIR™ probe from Alabama Specialty Products, Inc.

1. A method for determining the corrosion rate of a piece of equipment of a urea synthesis plant, said piece of equipment being in contact with a process fluid of said urea synthesis plant, which is an aqueous solution containing ammonium carbamate, wherein the method comprises the provision of electrodes immersed in said process fluid, said electrodes including at least a working electrode which is made of the same material as said piece of equipment, a reference electrode and a counter electrode, the method comprising the steps of:
a) determining polarization data of the working electrode, by varying the electrochemical potential of said working electrode relative to the reference electrode, and
b) determining a corrosion rate of said piece of equipment based on said polarization data;
wherein said electrodes are put in contact with said process fluid by installing said electrodes in a pressure vessel of said piece of equipment, or by withdrawing a portion of said process fluid from a line upstream or downstream said piece of equipment and sending said portion of said process fluid to a probe including the electrodes.

2. The method according to claim 1, wherein said step a) includes to sweep the electrochemical potential of said working electrode relative to the reference electrode and to measure the current flowing between the working electrode and the counter electrode.

3. The method according to claim 2, wherein in the step a) the electrochemical potential of said working electrode relative to the reference electrode is swept around the open circuit potential, said open circuit potential being the potential difference between the working electrode and the reference electrode measured in absence of an electric current circulating between the working electrode and the counter electrode.

4. The method according to claim 3, wherein said electrochemical potential is swept in a range between −20 mV and +20 mV versus said open circuit potential.

5. The method according to claim 4, wherein said electrochemical potential is swept with a scan rate lower than 20 mV/min.

6. The method according to any previous claim 1, wherein from the polarization data a polarization resistance R_{P} is calculated as follow:
$${R}_{P} = \frac{Δ E}{I}$$
wherein:
ΔE is the imposed potential difference at the working electrode calculated as
ΔE=E−OCP wherein E is the electrochemical potential of the working electrode and OCP is the open circuit potential;
I is the current flowing between the working electrode and the counter electrode in said ΔE.

7. The method according to claim 6, wherein the step b) includes the following steps:
determining a parameter B on the basis of the material of the working electrode and the composition of the process fluid;
determining a corrosion current I_{corr} as follow:
$${I}_{corr} = \frac{B}{R \text{?}}$$
$$\text{?} \text{indicates text missing or illegible when filed}$$
determining the corrosion rate Cᵣₐₜₑ as follow:
$${C}_{rate} = \frac{{I}_{corr}}{A} * K$$
wherein A is the surface area of the working electrode exposed to the process fluid and K is a conversion factor, wherein K is determined in accordance with ASTM G102-89;
wherein said parameter B is defined as follows:
B is in the range 3.0 to 6.0 mV when the working electrode is made of a super duplex stainless steel (austenitic-ferritic) and when it is immersed into an aqueous solution of ammonium carbamate and no passivating oxygen is injected into the solution, or
B is calculated from the following equation:
$$B = \frac{{b}_{a} * {b}_{c}}{2.3 * ( {b}_{a} + {b}_{c} )}$$
where the parameters bₐ is the anodic Tafel slope and be is the cathodic Tafel slope.

8. The method according to claim 7, wherein the working electrode is made of a super duplex stainless steel and is exposed to the process fluid not added with passivating oxygen, and B is in the range 3.5 to 5.0 mV.

9. The method according to claim 1, wherein the working electrode, the reference electrode, and the counter electrode, are made of the same material.

10. The method according to claim 1, wherein said piece of equipment is part of a high-pressure urea synthesis section or urea synthesis loop, particularly a urea synthesis reactor, a urea stripper, a urea condenser or a piece thereof.

11. The method according to any of the previous claim 1, wherein said working electrode, said reference electrode and said counter electrode are concentrically arranged on said probe.

12. The method according to claim 1, wherein the method is performed continuously.

13. The method according to claim 5, wherein the scan rate is lower than 10 mV/min.

14. The method according to claim 8, wherein B is 4.7 mV or around 4.7 mV.
